(19) United States
(12) Patent Application Publication
(10) Pub. No.: US 2025/0202783 A1
(43) Pub. Date: Jun. 19, 2025

(54) METHOD AND RELATED DEVICE FOR DATA PROCESSING

(71) Applicant: Beijing Zitiao Network Technology Co., Ltd., Beijing (CN)

(72) Inventors: Lei MA, Beijing (CN); Yifan YANG, Beijing (CN)

(21) Appl. No.: 18/979,313

(22) Filed: Dec. 12, 2024

(30) Foreign Application Priority Data
Dec. 14, 2023 (CN) 202311723054.6

(51) Int. Cl. H04L 43/028; H04W 24/02

(52) U.S. Cl. CPC H04L 43/028; H04W 24/02

(57) ABSTRACT

The invention provides a method for data processing, which includes the following steps: obtaining a device environment of a client; adjusting an amount of data returned to the client based on the device environment to obtain first data, and returning the first data to the client. Based on the method for data processing, the present disclosure further provides an apparatus, an electronic device, a storage medium, and a program product for data processing.

### CROSS REFERENCE

This application claims priority of Chinese Patent Application No. 202311723054.6, filed on Dec. 14, 2023, entitled ‘Method and Related Device for Data Processing’, the entire contents of which are incorporated herein by reference in its entirety.

### FIELD

The present disclosure relates to the field of mobile communications technologies, and in particular, to methods and a related devices for data processing.

### BACKGROUND

In the prior art, for a data request initiated by a client, fixed-length data is generally fed back, for example, 20 pieces of news, 20 videos, or 40 comments. However, when the device environment of the client is poor, for example, the hardware performance of the device itself or the network environment is poor, the problem that the consumed time is long and the input and output occupation is too high may occur when the data feedback is accepted, and for devices with good device environments, when the user consumes the content, it is necessary to initiate a request to the server multiple times to obtain related content, which may cause problem that the client needs to initiate multiple requests, and the number of requests per second of the server is too high.

### SUMMARY

In view of this, an object of the present disclosure is to provide a method and a related device for data processing.

Based on the above object, the present disclosure provides a method for processing data, comprising:

obtaining a device environment of a client;

adjusting an amount of data returned to the client based on the device environment to obtain first data, and returning the first data to the client.

Based on the foregoing method for data processing, an embodiment of the present disclosure provides an apparatus for data processing, comprising:

an obtaining module for obtaining a device environment of a client;

a returning module for adjusting an amount of data returned to the client based on the device environment to obtain first data, and return the first data to the client.

In addition, an embodiment of the present disclosure further provides an electronic device, comprising a memory, a processor, and a computer program stored on the memory and executable on the processor, wherein the program, when executed by the processor implements the foregoing method.

An embodiment of the present disclosure further provides a non-transitory computer-readable storage medium storing computer instructions, wherein the computer instructions are used to cause a computer to perform the foregoing method.

An embodiment of the present disclosure further provides a computer program product, comprising computer program instructions, wherein the computer program instructions, when running on a computer, cause the computer to perform the foregoing method.

It can be seen from the above content that, through the method for data processing provided by the present disclosure, the device environment of the client is obtained, and then the amount of data returned to the client is adjusted based on the device environment to obtain the first data, and the first data is returned to the client. According to the above method, the problem that under different device environments of different clients, due to the fact that the length of the returned data is fixed, the consumed time is long and the input and output occupation is too high when the device environment of the client is poor is solved, and the problem that when the device environment of the client is relatively good, the requests are initiated multiple times and the number of requests per second of the server is too high is solved.

### BRIEF DESCRIPTION OF THE DRAWINGS

In order to more clearly illustrate the technical solutions in the present disclosure or related technologies, the accompanying drawings, which need to be used in the description of the embodiments or related technologies, are briefly introduced below, and obviously, the drawings in the following description are merely embodiments of the present disclosure, and for those of ordinary skill in the art, other drawings may be obtained according to these drawings without creative work.

FIG. 1 shows an implementation flow of a method for data processing according to some embodiments of the present disclosure;

FIG. 2 shows a schematic flowchart of injecting a first device environment score according to an embodiment of the present disclosure;

FIG. 3 shows a schematic flowchart of adjusting an amount of returned data according to an embodiment of the present disclosure;

FIG. 4 shows an internal structure of an apparatus for data processing according to an embodiment of the present disclosure;

FIG. 5 shows a schematic structural diagram of the hardware of an electronic device according to an embodiment of the present disclosure.

### DETAILED DESCRIPTION

In order to make the objectives, technical solutions and advantages of the present disclosure clearer, the present disclosure will be further described in detail below with reference to the accompanying drawings.

It should be noted that, unless otherwise defined, technical terms or scientific terms used in the embodiments of the present disclosure should be of ordinary meanings understood by those skilled in the art to which the present disclosure belongs. The terms “first”, “second” and similar terms used in the embodiments of the present disclosure do not represent any order, quantity, or importance, but are merely used to distinguish different components. A word including” or “comprising” or the like means that an element or object appearing in front of the word encompasses elements or objects and their equivalents appearing behind the word, without excluding other elements or objects. Similar terms such as “connected” or “in connection” are not limited to physical or mechanical connections, but may include electrical connections, whether direct or indirect. “Upper”, “lower”, “left”, “right” and the like are only used to represent relative position relationships, and when the absolute position of the object to be described changes, the relative position relationship may also change accordingly.

It may be understood that, before the technical solutions of the embodiments of the present disclosure are used, the user may be notified of the type, the usage scope, the usage scenario of the involved personal information, and the like in an appropriate manner, and the authorization of the user is obtained.

For example, in response to receiving an active request from a user, prompt information is sent to the user to explicitly prompt the user that the operation requested to be performed will need to acquire and use the personal information of the user. Therefore, the user can autonomously select whether to provide personal information to software or hardware such as electronic device, application, server and storage device etc. executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining the user authorization process is merely illustrative, and does not constitute a limitation on implementations of the present disclosure, and other manners of meeting related laws and regulations may also be applied to implementation manners of the present disclosure.

As described above, in the prior art, for a data request initiated by a client, fixed-length data is generally fed back, for example, 20 pieces of news, 20 videos, or 40 comments. However, when the device environment of the client is poor, for example, the hardware performance of the device itself or the network environment is poor, the problem that the consumed time is long and the input and output occupation is too high may occur when the data feedback is accepted, and for devices with good device environments, when the user consumes the content, it is necessary to initiate a request to the server multiple times to obtain related content, which may cause problem that the client needs to initiate multiple requests, and the number of requests per second of the server is too high.

Therefore, some embodiments of the present disclosure provide a method for data processing, which may adjust the amount of data returned to a client by obtaining the device environment of the client, thereby enabling the returned data to be well adapted to the device environment of the client, effectively preventing the aforementioned problems, ensuring good operation of the client and the server, and greatly improving user experience. In an embodiment of the present disclosure, the method for data processing may be implemented by an electronic device having a computing capability.

FIG. 1 shows an implementation flow of a method for data processing according to an embodiment of the present disclosure. As shown in FIG. 1, the method may include the following steps:

In step 102, obtaining a device environment of a client.

In the embodiments of the present disclosure, different clients may have different device environments, the foregoing device environment may refer to a hardware parameter of the device itself, or may refer to an environment in which the device is currently located, for example, a current network speed, a network standard, and the like, and the device environment may further include a habit of using a corresponding application by the user. Certainly, the device environment may further include other content, and those skilled in the art may perform related addition and deletion according to their own needs, but it should be noted that, after the device environment is added or deleted, a specific method for subsequently adjusting the amount of data returned to the client according to the device environment also needs to be related adjusted, but the specific solution cannot be learned by those skilled in the art without paying creative labor, and therefore, the foregoing description of adding and deleting content of the device environment by those skilled in the art may be mainly used to describe that the device environment may also include many other content.

In an embodiment of the present disclosure, the device environment may include: device performance and network performance; obtaining the device environment of the client comprises: obtaining the device performance and the network performance of the client.

In some embodiments of the present disclosure, the device performance is determined based on hardware parameters of a device of the client. Specifically, the device performance may include hardware parameters of the device, for example, may be a central processing unit (CPU), a memory, a magnetic disk, and the like of the device, and a corresponding model may be referred to as a hardware parameter.

In an embodiment of the present disclosure, the obtaining process of the device performance may be directly obtaining the model corresponding to the hardware parameter, or may be performing performance measurement on hardware included in the foregoing device by using a predetermined algorithm. For example, letting the CPU of the device to run a calculation type algorithm, then obtaining the time consumed by the device, and the consumed time is used to represent the device performance corresponding to the CPU; correspondingly, the read/write algorithm can be used to test the time consumption of reading and writing copies of the memory and the time consumption of reading and writing copies of the magnetic disk, and the time consumption corresponding to the respective component is the corresponding device performance thereof.

In some embodiments of the present disclosure, the device performance may further include performance of video encoding, and correspondingly, when the video encoding capability is obtained, the performance of the video encoding may be tested by using a video encoding algorithm.

In some embodiments of the present disclosure, network performance may include network speed. When obtaining the network speed of the client, the network speed carried in the current device initiated request may be directly determined as the network speed used to determine the network performance.

In some embodiments of the present disclosure, when obtaining the network speed of the client, the network speed for sending the request in a period of time may be obtained, and the median of it is taken as the network speed for determining the network performance. In this way, the network speed is determined, and the influence of unstable network speed caused by network fluctuation on the subsequent calculation process can be effectively avoided during network fluctuation.

In some embodiments of the present disclosure, the network performance may further include a network standard, a common network standard, for example, a second generation mobile phone communication technology specification, a third generation mobile phone communication technology specification, a fourth generation mobile phone communication technology specification, a fifth generation mobile phone communication technology specification, a mobile hotspot, and the like. When obtaining network performance, it may be implemented in a form of obtaining a network standard. However, the manner in which the network performance is obtained by means of the network standard is inflexible, because the real time network speed of the devices with relatively advanced network standards is often lower than the real time network speed of the devices with relatively unadvanced the network standard, which obviously does not meet the original intention of the design, but the reason for setting the embodiment is because when the application is performing a cold start, no network speed data is supplied to the server for obtaining, so that the network performance of the device cannot be determined through the network speed at this time, therefore, the network performance of the device can be temporarily obtained through the inherent network standard, so as to avoid the consequences that the application cannot provide the network speed data during cold start so that subsequent steps cannot be performed.

Further, after the device environment of the client is obtained. In step 104, adjusting an amount of data returned to the client based on the device environment to obtain first data, and returning the first data to the client.

In the embodiment of the present disclosure, in the process of adjusting the amount of data returned to the client based on the device environment, the corresponding score of the parameter included in the device environment needs to be calculated, and the amount of data returned to the client is further adjusted depending on the score.

In an embodiment of the present disclosure, adjusting a size of data returned to the client based on the device environment comprises: calculating a device performance score of the client based on the device performance; calculating a network performance score of the client based on the network performance; calculating a first device environment score of the client based on the device performance score, the network performance score, a weight corresponding to the device performance score and a weight corresponding to the network performance score; and adjusting the size of data returned to the client based on the first device environment score.

Based on the foregoing steps, the obtaining process of the device performance may be directly obtaining the model corresponding to the foregoing hardware parameter, or may be obtained by performing performance measurement on the hardware included in the foregoing device by using a predetermined algorithm.

In some embodiments of the present disclosure, if the obtaining process of the device performance is to directly obtain the model corresponding to the hardware parameter, when obtaining the device performance score of the client based on the calculation of the device performance, the server may first obtain the hardware data of the device initiating the request, set the score of the different hardware parameters based on the obtained data. Taking the CPU as an example, the score set for the top-end CPU may be relatively high, which may be set in the interval of 8-10. For the mid-end central processor, the score interval may be set approximately between 6-8, and the rest are set in the interval of 0-6. Certainly, each interval comprises a plurality of types of CPUs, and respective models of CPUs are subdivided in each interval, and finally each model of CPU is guaranteed to be set with a corresponding score. Correspondingly, for other hardware, such as memory, magnetic disk, and the like, a large amount of reference data is also obtained at the server, and the scores of memories and magnetic disks of different performance are determined under a large amount of reference data, to ensure that the memories or magnetic disks of different models each have their corresponding device performance scores. After score division is performed on different types of hardware, different hardware needs to be divided for weights, and the weights can be divided in the form of averaging when setting. In some other embodiments, the hardware resources corresponding to the main requirements of the application can also be determined, because the requirements on the hardware for different applications are different, some applications may place emphasis on occupying the resource of the CPU, some applications may place emphasis on occupying the memory resources, different applications have different characteristics, and therefore, proper adjustment can also be made according to the specific situation of the application on the distribution of the weights, so that the data can be more adaptive to different applications in addition to adapting to the device during transmission, and the user experience can be effectively improved.

In some embodiments of the present disclosure, if the obtaining process of the device performance is performed by calculating time consumption for each piece of hardware of the device through different algorithms, the corresponding time is taken to obtain the corresponding score. For example, it takes 10 milliseconds of time consumption for the CPU to run a calculation type algorithm, then its score is set to 9; the memory read/write copy time is 15 seconds, then its score is set to 8; the time consumption of reading/writing copies by the magnetic disk, its score is set to 2; the time consumption of the device running a video coding algorithm, its score is set to 3. Correspondingly, the mapping relationship between the time and the score may also be determined by the manner of obtaining a large amount of data by using the server, which is similar to the foregoing steps, and details are not described herein again.

In the foregoing step, whether the corresponding device performance score is obtained by directly obtaining the model corresponding to the hardware parameter or by calculating the time consumption of the hardware by using different algorithms is essentially a division on the existing hardware performance utilization score in the market, so that the device performance can be quantified by the present application, that is, the device performance is intuitively presented by using the score, so that calculation of subsequent steps can be facilitated.

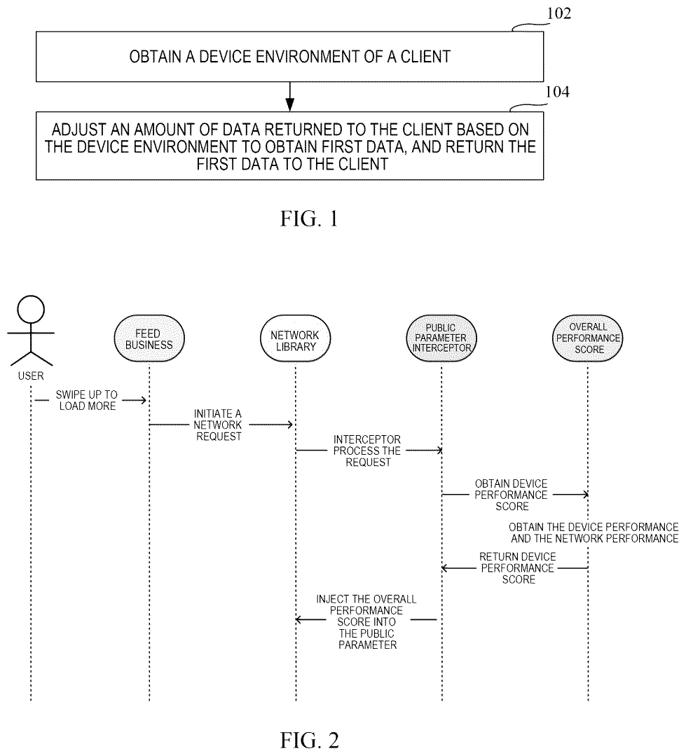

FIG. 2 shows a schematic flowchart of injecting a first device environment score according to an embodiment of the present disclosure.

As shown in FIG. 2, when the user consumes content, a corresponding network request is initiated to the server, and at this time, the public parameter interceptor performs corresponding processing on the initiated request, and then obtains a corresponding device performance score, that is, the device performance score and the network performance score calculated in the foregoing step, and then injects the first device environment score calculated based on the device performance score and the network performance score into the public parameter. Specifically, in the foregoing step, after the device performance score of the client is calculated, the device performance score of the client is correspondingly stored in the client, and when the data request is initiated to the server, the stored device performance score may be added to the request parameter by using the public parameter interceptor to provide to the server to use for calculating the first device environment score.

In some embodiments of the present disclosure, the network performance comprises a network speed; calculating the network performance score of the client based on the network performance comprises: calculating the network performance score of the client based on the network speed. When the network performance is the network speed, the server first needs to determine the threshold of the network performance score corresponding to the network speed, that is, at different network speeds, what the corresponding network performance score is specifically. In the process of determining the score threshold, firstly, similarly, the network speed of a large number of devices needs to be obtained, and a network speed set is formed, then the network speed sequences in the network speed set are sorted, then the threshold of the network speed corresponding to each quantile is determined, for example, 100 pieces of data are collected in total, when setting the threshold, the network speed corresponding to the 50th data may be set as the threshold corresponding to the score 5, similarly, the network speed corresponding to the 40th data may be set as the threshold corresponding to the score 4, and so on. The network speed is not directly averaged to set the threshold, because the network speed of the user is roughly normally distributed, the network speeds of a large number of users tend to be the same, and the number of users corresponding to the extreme values at the two ends is small, therefore, if the network speed is simply averaged to set the thresholds, the final result will not be accurate enough, thereby affecting the amount of data finally returned to the user, which affects the user experience.

In some embodiments of the present disclosure, the method further comprises: in response to a network fluctuation event, obtaining a predetermined number of fluctuating network speeds corresponding to a requests of the client; and using a median of the predetermined number of fluctuating network speeds as the network speed for determining the network performance score. When the network fluctuates, if determining the network speed cannot be as simple as described in the foregoing step, the fluctuating network speed in a period of time of the client at which the network fluctuation occurs needs to be collected, and then the median of the predetermined number of fluctuating network speeds is used as the network speed for determining the network performance score, so that frequent changes of the amount of data returned caused by frequent fluctuation of the network, resulting in the data return process being extremely instability can be effectively avoided, and adverse consequences such as blockage, delay and the like can be effectively avoided.

In some embodiments of the present disclosure, the method further comprises: in response to a network fluctuation event, obtaining a predetermined number of fluctuating network speeds corresponding to a request of the client; setting a weight corresponding to each of fluctuation network speeds; calculating a predetermined number of weighted network speeds based on each of the weights and each of the corresponding fluctuation network speeds; calculating a half of a sum of each of the weighted network speeds, and matching, from each of the fluctuating network speeds, the fluctuating network speed closest to the half of the sum of the weighted network speeds; and using the fluctuating network speed closest to the half of the sum of the weighted network speeds as the network speed for determining the network performance score. In the solution provided herein, the network speed for determining the network performance score is also obtained, and the difference lies in that the foregoing solution only takes the median of the plurality of network speeds as a representative, and in the solution in this embodiment, the corresponding weights are set for the obtained plurality of fluctuating network speeds, specifically, the closer the obtaining time is, the larger the weight value corresponding to the fluctuating network speed, because it can represent the current network speed condition better, thus the weight value of the fluctuating network speed closer to the current time will be set correspondingly larger, and it should be noted that, when obtaining the fluctuating network speed, it is necessary to record the weight corresponding to the fluctuating network speed, the time consumed for returning the data, and the network speed when the data is returned this time. The weighted network speed, that is, the product of the weight and the fluctuating network speed, is calculated according to the foregoing data. In some embodiments, the number of the obtained fluctuating network speeds is 10, and firstly, the 10 records are sorted, and the half of the sum of the weighted network speeds is calculated, at this time, the obtained fluctuating network speeds are traversed, and the network speed value corresponding to the record of the half of the sum of the weighted network speeds is taken as the value for determining the network performance score.

In some embodiments of the present disclosure, the network performance comprises a network standard; calculating the network performance score of the client based on the network performance comprises: calculating the network performance score of the client based on the network standard. When the network performance is the network standard, the server directly obtains the network standard corresponding to the device, and then determines the corresponding network performance score according to the obtained network standard. Because the solution is mainly provided for the application cold start, thus the score setting may be relatively simple, for example, the score for the specification of the second generation mobile phone communication technology is set to 2, the score for the specification of the third generation mobile phone communication technology is set to 5, the score for the specification of the fourth generation mobile phone communication technology is set to 8, the score for the specification of the fifth generation mobile phone communication technology is set to 10, and the score for the mobile hotspot is set to 8.

For the foregoing network performance score, after the client initiates the request to the server, the network speed determined in the foregoing step and the network standard of the current device may be injected into the request parameter by using the public parameter interceptor, and finally uploaded to the server.

After the device performance score and the network performance score are calculated based on the foregoing steps, the first device environment score is calculated based on the foregoing two scores and the weights corresponding to the two scores.

In an embodiment of the present disclosure, the method further comprises: in response to the device performance score being greater than the network performance score, setting the weight corresponding to the device performance score to be less than the weight corresponding to the network performance score; and in response to the device performance score being less than the network performance score, setting the weight corresponding to the device performance score to be greater than the weight corresponding to the network performance score.

When setting the weights of the two scores, the weights of the two scores may be adjusted correspondingly according to the size relationship between the two scores. For example, when the device performance score is greater than the network performance score, the weight corresponding to the device performance score may be adjusted to be less than the weight corresponding to the network performance score. Because of the calculation result of the foregoing steps, that is, the first device environment score will affect the amount of data transmitted, while in the process of data transmission, it is mainly limited by the side with a lower score, that is, the amount of data transmitted is mainly affected by the lower limit of the device environment. Therefore, when setting the weights, the weight of the side with a lower score may be set relatively large, so that the stableness of the transmission process may be ensured, and the situation where the finally selected amount of data for returning is not adapted to one side of the two can be effectively avoided. Similarly, if the device performance score is less than the network performance score, the weight corresponding to the device performance score is adjusted to be greater than the weight corresponding to the network performance score. The specific reason is the same as the foregoing discussion, and details are not described herein again.

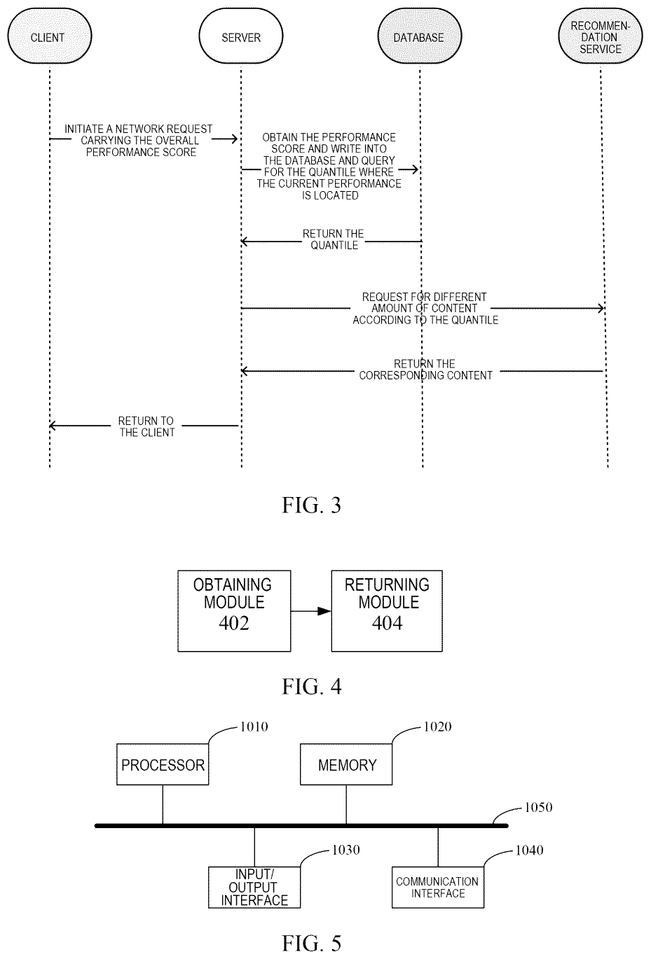

Referring to FIG. 3, which shows a schematic flowchart of adjusting an amount of returned data according to an embodiment of the present disclosure.

As shown in FIG. 3, the client may carry the device performance and the network performance, and initiate network request, and then the server determines the final device environment score according to the information carried in the network request, and then determines the returned data amount according to the score, and finally returns the corresponding content to the client according to the amount.

In an embodiment of the present disclosure, the device environment further comprises a historical browsing speed; obtaining the device environment of the client further comprises: obtaining a historical browsing speed of the client. The historical browsing speed may be the historical browsing speed of the user when using the application, and in actual use process, the device performance, the network performance, and the historical browsing speed of the client need to be comprehensively considered. This is to meet the client that the device performance score and the network performance score are relatively good, but the browsing speed of the user is relatively slow, and for this case, there is no need to return too much data to the client at a time because the browsing speed of the user is slow. Therefore, it can be seen that the embodiments of the present disclosure can effectively avoid waste of resources in the process of returning data.

Further, in an embodiment of the present disclosure, adjusting the size of data returned to the client based on the device environment comprises: calculating a device performance score of the client based on the device performance; calculating a network performance score of the client based on the network performance; calculating a historical browsing score of the client based on the historical browsing speed; calculating a second device environment score of the client based on the device performance score, the network performance score, the historical browsing score, a weight corresponding to the device performance score, a weight corresponding to the network performance score, and a weight corresponding to the historical browsing score; and adjusting the size of data returned to the client based on the second device environment score.

Similarly, the process of calculating the device performance score and the network performance score is as described above, and details are not described herein again. The difference herein is that, in the embodiment of the present disclosure, the historical browsing score corresponding to the client is further calculated based on the historical browsing speed, and the second device environment score is synthetically calculated based on the weights corresponding to the three types of scores. Then, the data size returned to the client is adjusted according to the second device environment score.

In an embodiment of the present disclosure, the method further comprises: obtaining an amount of the first data consumed by the client; and in response to the amount reaching a predetermined threshold, returning a corresponding amount of second data to the client.

For certain users, the scheme of adjusting the return data greatly reduces the amount of returned data at a single time compared with the previous scheme, and sometimes leads to the existence of a consistency problem when the user browses the application, and then the continuity of browsing of the user can be ensured through the pre-loading manner. For example, the user can consume 50 pieces of data at a time, and the optimized solution can only consume 10 pieces of data at one time, and when the user consumes the seventh piece of data, the application can actively trigger the network request once, thereby obtaining the second batch of data. In this way, the damage of the consistency of the user during consumption of the data can be largely avoided, and the fluency of the user when browsing the data can be effectively ensured.

In an embodiment of the present disclosure, a magnitude of the first device environment score is directly proportional to an amount of the first data returned to the client.

In an embodiment of the present disclosure, a magnitude of the second device environment score is directly proportional to an amount of the first data returned to the client.

Similarly, the first device environment score and the second device environment score mentioned in the foregoing embodiment are similar: the larger the magnitude of the two, the more the data returned to the client is, the two are directly proportional

According to the above method for data processing, the device environment of the client is obtained, the amount of data returned to the client is adjusted based on the device environment, the first data is obtained, and the first data is returned to the client. According to the method, the problem that in different device environments of different clients, due to the fact that the length of the returned data is fixed, the consumed time is long and the input and output occupation is too high when the device environment of the client is poor is solved, and the problem that when the device environment of the client is relatively good, the request is initiated for multiple times and the number of requests per second of the server are high is solved.

It should be noted that the method in the embodiments of the present disclosure may be performed by a single device, for example, a computer or a server. The method in this embodiment may also be applied to a distributed scenario, and the plurality of devices cooperate to complete. In this distributed scenario, one of the plurality of devices may perform only one or more steps in the method in the embodiments of the present disclosure, and the plurality of devices interact with each other to complete the method.

It should be noted that some embodiments of the present disclosure are described above. Other embodiments are within the scope of the appended claims. In some cases, the acts or steps recited in the claims may be performed in a different order than in the above embodiments and still achieve the desired results. Additionally, the processes depicted in the figures do not necessarily require a particular order or sequential order shown to achieve the desired results. In certain embodiments, multitasking and parallel processing are also possible or may be advantageous.

Corresponding to the method for data processing, an embodiment of the present disclosure further discloses an apparatus for data processing. FIG. 4 shows an internal structure of an apparatus for data processing according to an embodiment of the present disclosure. As shown in FIG. 4, the apparatus may include:

an obtaining module 402 for obtaining a device environment of a client.

a returning module 404 for adjusting an amount of data returned to the client based on the device environment to obtain first data, and return the first data to the client.

In some embodiments of the present disclosure, the device environment includes: device performance and network performance.

The obtaining module 402 includes:

a first obtaining unit for obtaining the device performance and the network performance of the client.

In some embodiments of the present disclosure, wherein the device environment further comprises a historical browsing speed.

The obtaining module 402 further includes:

a second obtaining unit for obtaining a historical browsing speed of the client.

In some embodiments of the present disclosure, the returning module 404 includes:

a device performance calculation unit for calculating a device performance score of the client based on the device performance; and

a network performance calculation unit for calculating a network performance score of the client based on the network performance; and

a first device environment score calculation unit for calculating a first device environment score of the client based on the device performance score, the network performance score, a weight corresponding to the device performance score and a weight corresponding to the network performance score; and

a first adjustment unit for adjusting the size of data returned to the client based on the first device environment score.

In some embodiments of the present disclosure, the returning module 404 includes:

a device performance calculation unit for calculating a device performance score of the client based on the device performance; and

a network performance calculation unit for calculating a network performance score of the client based on the network performance; and

a historical browsing score calculation unit for calculating a historical browsing score of the client based on the historical browsing speed;

a second device environment score calculation unit for calculating a second device environment score of the client based on the device performance score, the network performance score, the historical browsing score, a weight corresponding to the device performance score, a weight corresponding to the network performance score, and a weight corresponding to the historical browsing score; and

a second adjustment unit for adjusting the size of data returned to the client based on the second device environment score.

In some embodiments of the present disclosure, the device performance is calculated based on a hardware parameter of a device of the client.

In some embodiments of the present disclosure, the network performance includes a network speed.

The device performance calculation unit includes:

calculating the network performance score of the client according to the network speed.

In some embodiments of the present disclosure, the network performance comprises a network standard.

The network performance calculation unit includes:

calculating the network performance score of the client according to the network standard.

In some embodiments of the present disclosure, the method further includes:

a first response module for in response to the device performance score being greater than the network performance score, setting the weight corresponding to the device performance score to be less than the weight corresponding to the network performance score; and

a second response module for in response to the device performance score being less than the network performance score, setting the weight corresponding to the device performance score to be greater than the weight corresponding to the network performance score.

In some embodiments of the present disclosure, the method further includes:

A first network fluctuation event responding module for, in response to a network fluctuation event, obtaining a predetermined number of fluctuating network speeds corresponding to a requests of the client;

A median module for using a median of the predetermined number of fluctuating network speeds as the network speed for determining the network performance score.

In some embodiments of the present disclosure, the method further includes:

A second network fluctuation event responding module for, in response to a network fluctuation event, obtaining a predetermined number of fluctuating network speeds corresponding to a request of the client;

A weight setting module for setting a weight corresponding to each of fluctuation network speeds;

A weighted network speed calculation module for calculating a predetermined number of weighted network speeds based on each of the weights and each of the corresponding fluctuation network speeds;

A matching module for calculating a half of a sum of each of the weighted network speeds, and matching, from each of the fluctuating network speeds, the fluctuating network speed closest to the half of the sum of the weighted network speeds;

A network speed determining module for using the fluctuating network speed closest to the half of the sum of the weighted network speeds as the network speed for determining the network performance score.

In some embodiments of the present disclosure, the method further includes:

A first data obtaining module for obtaining an amount of the first data consumed by the client;

A third response module for in response to the amount reaching a predetermined threshold, returning a corresponding amount of second data to the client.

In some embodiments of the present disclosure, wherein a magnitude of the first device environment score is directly proportional to an amount of the first data returned to the client.

In some embodiments of the present disclosure, wherein a magnitude of the second device environment score is directly proportional to an amount of the first data returned to the client.

For convenience of description, the above apparatus is described as the above apparatus is divided into various modules for description. Of course, the functions of each of the modules may be implemented in one or more software and/or hardware when implementing the present disclosure.

The apparatus of the foregoing embodiment is configured to implement the corresponding method for data processing in any one of the foregoing embodiments, and has the beneficial effects of the corresponding method embodiments, and details are not described herein again.

Based on the same inventive concept, the present disclosure further provides an electronic device, including a memory, a processor, and a computer program stored in the memory and executable on the processor, where when the processor executes the program, the method for data processing according to any one of the above embodiments is implemented.

FIG. 5 is a schematic structural diagram of a more specific hardware structure of an electronic device according to this embodiment, and the device may include a processor 1010, a memory 1020, an input/output interface 1030, a communication interface 1040, and a bus 1050. The processor 1010, the memory 1020, the input/output interface 1030, and the communication interface 1040 implement, by using the bus 1050, a communication connection with each other inside the device.

The processor 1010 may be implemented by using a general-purpose central processing unit (CPU), a microprocessor, an application specific integrated circuit (ASIC), or one or more integrated circuits, and is configured to execute related programs to implement the technical solutions provided in the embodiments of the present specification.

The memory 1020 may be implemented in a form of a ROM (Read Only Memory), a Random Access Memory (RAM), a static storage device, a dynamic storage device, or the like. The memory 1020 may store an operating system and other applications, and when implementing the technical solutions provided in the embodiments of the present specification by using software or firmware, related program code is stored in the memory 1020 and invoked and executed by the processor 1010.

The input/output interface 1030 is configured to connect the input/output module to implement information input and output. The input/output/module may be configured as a component in the device (not shown in the figure), or may be externally connected to the device to provide a corresponding function. The input device may include a keyboard, a mouse, a touch screen, a microphone, various sensors, etc., and the output device may include a display, a speaker, a vibrator, an indicator light, and the like.

The communication interface 1040 is configured to connect a communication module (not shown in the figure), to implement communication interaction between the device and another device. The communication module may implement communications in a wired manner (for example, a USB or a network cable), or may implement communications in a wireless manner (for example, a mobile network, a Wi-Fi, a Bluetooth, and the like).

The bus 1050 includes a path to transfer information between various components of the device, such as the processor 1010, the memory 1020, the input/output interface 1030, and the communication interface 1040.

It should be noted that although the foregoing device only shows the processor 1010, the memory 1020, the input/output interface 1030, the communication interface 1040, and the bus 1050, in a specific implementation process, the device may further include other components necessary to implement normal running. In addition, those skilled in the art may understand that the foregoing device may also include only components necessary for implementing the solutions in the embodiments of the present specification, and does not necessarily include all components shown in the figure.

The electronic device of the foregoing embodiment is configured to implement the corresponding method for data processing in any one of the foregoing embodiments, and has the beneficial effects of the corresponding method embodiments, and details are not described herein again.

Based on the same inventive concept, the present disclosure further provides a non-transitory computer-readable storage medium storing computer instructions for causing the computer to perform the method for data processing according to any one of the above embodiments.

Computer-readable media of the present embodiments include permanent and non-permanent, removable and non-removable media that can be stored by any method or technology. The information may be computer readable instructions, data structures, modules of a program, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transmission medium, which can be used to store information that can be accessed by a computing device.

The computer instructions stored in the storage medium in the foregoing embodiments are configured to cause the computer to perform the method or data processing according to any one of the foregoing embodiments, and have the beneficial effects of the corresponding method embodiments, and details are not described herein again.

Based on the same inventive concept, corresponding to the method for data processing according to any one of the above embodiments, the present disclosure further provides a computer program product, including computer program instructions. In some embodiments, the computer program instructions may be executed by one or more processors of a computer to cause the computer and/or the processor to perform the method for data processing. Corresponding to the executing body corresponding to each step in the embodiments of the method for data processing, the processor executing the corresponding step may belong to the corresponding executing body.

The computer program product of the foregoing embodiment is configured to cause the computer and/or the processor to perform the method for data processing according to any one of the foregoing embodiments, and has the beneficial effects of the corresponding method embodiments, and details are not described herein again.

It should be understood by those of ordinary skill in the art that the discussion of any of the above embodiments is merely exemplary and is not intended to suggest that the scope of the present disclosure, including the claims, is limited to these examples; in the spirit of the present disclosure, the above embodiments or the technical features in different embodiments may also be combined, the steps may be implemented in any order, and there are many other variations of the different aspects of the embodiments of the present disclosure as described above, which are not provided in detail for the sake of brevity.

Additionally, for simplicity of illustration and discussion, and to not obscure embodiments of the present disclosure, well-known power/ground connections to integrated circuit (IC) chips and other components may or may not be shown in the figures provided. Moreover, the apparatus may be shown in block diagram form in order to avoid obscuring the embodiments of the present disclosure, and this also takes into account the fact that the details regarding the implementation of these block diagram apparatuses are highly dependent on the platform in which the embodiments of the present disclosure are to be implemented (i.e., these details should be fully within the understanding of those skilled in the art). Having set forth specific details (e.g., circuits) to describe exemplary embodiments of the present disclosure, it will be apparent to those skilled in the art that embodiments of the present disclosure may be practiced without these specific details or with changes to these specific details. Accordingly, these descriptions should be considered illustrative and not limiting.

Although the present disclosure has been described in conjunction with specific embodiments of the present disclosure, many alternatives, modifications, and variations of these embodiments will be apparent to those of ordinary skill in the art from the foregoing description. For example, other memory architectures (e.g., dynamic RAM (DRAM)) may use the embodiments discussed.

The present disclosure is intended to cover all such alternatives, modifications and variations that fall within the broad scope of the appended claims. Therefore, any omission, modification, equivalent replacement, improvement and the like that are made within the spirit and principle of the embodiments of the present disclosure should be included within the protection scope of the present disclosure.

I/we claim:

1. A method for data processing, comprising:
obtaining a device environment of a client; and
adjusting an amount of data returned to the client based on the device environment to obtain first data, and returning the first data to the client.

2. The method of claim 1, wherein the device environment comprises: device performance and network performance;
obtaining the device environment of the client comprises:
obtaining the device performance and the network performance of the client.

3. The method of claim 2, wherein the device environment further comprises a historical browsing speed;
obtaining the device environment of the client further comprises:
obtaining a historical browsing speed of the client.

4. The method of claim 2, wherein adjusting a size of data returned to the client based on the device environment comprises:
calculating a device performance score of the client based on the device performance;
calculating a network performance score of the client based on the network performance;
calculating a first device environment score of the client based on the device performance score, the network performance score, a weight corresponding to the device performance score and a weight corresponding to the network performance score; and
adjusting the size of data returned to the client based on the first device environment score.

5. The method of claim 3, wherein adjusting the size of data returned to the client based on the device environment comprises:
calculating a device performance score of the client based on the device performance;
calculating a network performance score of the client based on the network performance;
calculating a historical browsing score of the client based on the historical browsing speed;
calculating a second device environment score of the client based on the device performance score, the network performance score, the historical browsing score, a weight corresponding to the device performance score, a weight corresponding to the network performance score, and a weight corresponding to the historical browsing score; and
adjusting the size of data returned to the client based on the second device environment score.

6. The method of claim 4, wherein the device performance is determined based on a hardware parameter of a device of the client.

7. The method of claim 4, wherein the network performance comprises a network speed;
calculating the network performance score of the client based on the network performance comprises:
calculating the network performance score of the client based on the network speed.

8. The method of claim 4, wherein the network performance comprises a network standard;
calculating the network performance score of the client based on the network performance comprises:
calculating the network performance score of the client based on the network standard.

9. The method of claim 4, further comprising:
in response to the device performance score being greater than the network performance score, setting the weight corresponding to the device performance score to be less than the weight corresponding to the network performance score; and
in response to the device performance score being less than the network performance score, setting the weight corresponding to the device performance score to be greater than the weight corresponding to the network performance score.

10. The method of claim 7, further comprising:
in response to a network fluctuation event, obtaining a predetermined number of fluctuating network speeds corresponding to a requests of the client; and
using a median of the predetermined number of fluctuating network speeds as the network speed for determining the network performance score.

11. The method of claim 7, further comprising:
in response to a network fluctuation event, obtaining a predetermined number of fluctuating network speeds corresponding to a request of the client;
setting a weight corresponding to each of fluctuation network speeds;
calculating a predetermined number of weighted network speeds based on each of the weights and each of the corresponding fluctuation network speeds;
calculating a half of a sum of each of the weighted network speeds, and matching, from each of the fluctuating network speeds, the fluctuating network speed closest to the half of the sum of the weighted network speeds; and
using the fluctuating network speed closest to the half of the sum of the weighted network speeds as the network speed for determining the network performance score.

12. The method of claim 1, further comprising:
obtaining an amount of the first data consumed by the client; and
in response to the amount reaching a predetermined threshold, returning a corresponding amount of second data to the client.

13. The method of claim 4, wherein a magnitude of the first device environment score is directly proportional to an amount of the first data returned to the client.

14. The method of claim 5, wherein a magnitude of the second device environment score is directly proportional to an amount of the first data returned to the client.

15. An electronic device, comprising a memory, a processor, and a computer program stored on the memory and executable on the processor, wherein the program, when executed by the processor implements the method for data processing, comprising:
obtaining a device environment of a client; and
adjusting an amount of data returned to the client based on the device environment to obtain first data, and returning the first data to the client.

16. The electronic device of claim 15, wherein the device environment comprises: device performance and network performance;
obtaining the device environment of the client comprises:
obtaining the device performance and the network performance of the client.

17. The electronic device of claim 16, wherein the device environment further comprises a historical browsing speed;
obtaining the device environment of the client further comprises:
obtaining a historical browsing speed of the client.

18. The electronic device of claim 16, wherein adjusting a size of data returned to the client based on the device environment comprises:
calculating a device performance score of the client based on the device performance;
calculating a network performance score of the client based on the network performance;
calculating a first device environment score of the client based on the device performance score, the network performance score, a weight corresponding to the device performance score and a weight corresponding to the network performance score; and
adjusting the size of data returned to the client based on the first device environment score.

19. The electronic device of claim 17, wherein adjusting the size of data returned to the client based on the device environment comprises:
calculating a device performance score of the client based on the device performance;
calculating a network performance score of the client based on the network performance;
calculating a historical browsing score of the client based on the historical browsing speed;
calculating a second device environment score of the client based on the device performance score, the network performance score, the historical browsing score, a weight corresponding to the device performance score, a weight corresponding to the network performance score, and a weight corresponding to the historical browsing score; and
adjusting the size of data returned to the client based on the second device environment score.

20. A non-transitory computer-readable storage medium storing computer instructions, wherein the computer instructions are used to cause a computer to perform the method for data processing, comprising:
obtaining a device environment of a client; and
adjusting an amount of data returned to the client based on the device environment to obtain first data, and returning the first data to the client.
